(19) United States
(12) Patent Application Publication
(10) Pub. No.: US 2015/0123798 A1
(43) Pub. Date: May 7, 2015

(54) METHODS AND SYSTEMS FOR PHOTOVOLTAIC SYSTEM MONITORING

(71) Applicant: SunEdison, Inc., Maryland Heights, MO (US)

(72) Inventors: Andras Boross, Belmont, CA (US); Vladimir Bezrukov, San Mateo, CA (US)

(21) Appl. No.: 14/072,485

(22) Filed: Nov. 5, 2013

(51) Int. Cl. G08B 21/00

(52) U.S. Cl. CPC G08B 21/00
USPC 340/540

(57) ABSTRACT

In one example, a method of monitoring a photovoltaic (PV) system located at a first location includes receiving, by a gateway device at the first location, data concerning a plurality of components of the PV system, determining, by the gateway device, if the received data satisfies at least one alert condition, and transmitting, by the gateway device, an alert notification to a computing device located at a second location when the received data satisfies at least one alert condition.

### FIELD

The field of the disclosure relates generally to photovoltaic (PV) systems. More particularly, this disclosure relates to methods and systems for monitoring PV systems.

### BACKGROUND

Photovoltaic (PV) modules (also known as solar modules) convert solar energy into electrical energy. The electrical energy may be used directly at the site, converted for local use, and/or converted and transmitted to an electrical grid or another destination. Typically, a PV installation includes at least a plurality of PV modules logically or physically grouped together to form an array and one or more inverters that convert the direct current (DC) output of the PV modules to alternating current (AC) power.

Some known PV systems collect operational data about the PV system and transmit the data from the PV system location to a remotely located backend system that monitors multiple PV systems. The operational data is generally stored, analyzed, and/or available for retrieval from the backend system. The amount of data received and stored, and the computational resources needed by the backend system increases greatly as the number of PV systems monitored by the backend system increases. In some systems, when an expected datum is not received, the datum is assigned a value of zero, which may not be distinguishable by a backend system from a datum whose value is actually zero.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

In one aspect, a method of monitoring a photovoltaic (PV) system located at a first location includes receiving, by a gateway device at the first location, data concerning a plurality of components of the PV system, determining, by the gateway device, if the received data satisfies at least one alert condition, and transmitting, by the gateway device, an alert notification to a computing device located at a second location when the received data satisfies at least one alert condition.

In another aspect, a gateway device for acquiring data concerning a photovoltaic (PV) system including a plurality of PV components at a first location is described. The gateway device includes a processor and a memory coupled to the processor. The memory includes computer-executable instructions that, when executed by the processor, cause the gateway device to: receive data concerning the plurality of components of the PV system, determine if the received data satisfies at least one alert condition, and transmit an alert notification to a computing device located at a second location when the received data satisfies at least one alert condition.

Another aspect of the present disclosure is a computer-readable storage device having non-transitory, computer-executable instructions embodied thereon. When executed by a gateway device at a first location comprising a processor and a memory coupled to the processor, the computer-executable instructions cause the gateway device to: receive data concerning a plurality of components of a photovoltaic (PV) system located at the first location, determine if the received data satisfies at least one alert condition, and transmit an alert notification to a computing device located at a second location when the received data satisfies at least one alert condition.

Yet another aspect is a method of monitoring a photovoltaic (PV) system located at a first location. The method includes: receiving, by a gateway device at the first location, data concerning a plurality of components of the PV system, detecting, by the gateway device, that communication between the gateway device and a first component of the plurality of PV components has been interrupted and that a data element associated with the first component has not been received, and transmitting, to a computing device located at a second location, an indication that communication between the gateway device and the first component has been interrupted.

In another aspect, a gateway device for acquiring data concerning a photovoltaic (PV) system including a plurality of PV components at a first location is described. The gateway device comprising a processor and a memory coupled to the processor. The memory comprises computer-executable instructions that, when executed by the processor, cause the gateway device to: receive data concerning a plurality of components of the PV system, detect that communication between the gateway device and a first component of the plurality of PV components has been interrupted and that a data element associated with the first component has not been received, and transmit, to a computing device located at a second location, an indication that communication between the gateway device and a first component of the plurality of PV components has been interrupted.

Another aspect of this disclosure is a computer-readable storage device having non-transitory, computer-executable instructions embodied thereon. When executed by a gateway device comprising a processor and a memory coupled to the processor, the computer-executable instructions cause the gateway device to: receive data concerning a plurality of components of the PV system, detect that communication between the gateway device and a first component of the plurality of PV components has been interrupted and that a data element associated with the first component has not been received, and transmit, to a computing device located at a second location, an indication that communication between the gateway device and a first component of the plurality of PV components has been interrupted.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a perspective view of an example photovoltaic (PV) module;

FIG. 2 is a cross-sectional view of the PV module shown in FIG. 1 taken along the line A-A;

FIG. 3 is a block diagram of an example computing device;

FIG. 4 is a block diagram of an example PV system;

FIG. 5 is a flow diagram of an example method of monitoring a PV system; and

FIG. 6 is a flow diagram of another example method of monitoring a PV system.

Like reference symbols in the various drawings indicate like elements.

### DETAILED DESCRIPTION

The embodiments described herein generally relate to photovoltaic (PV) systems. More particularly, the embodiments described herein relate to methods and systems for monitoring PV systems.

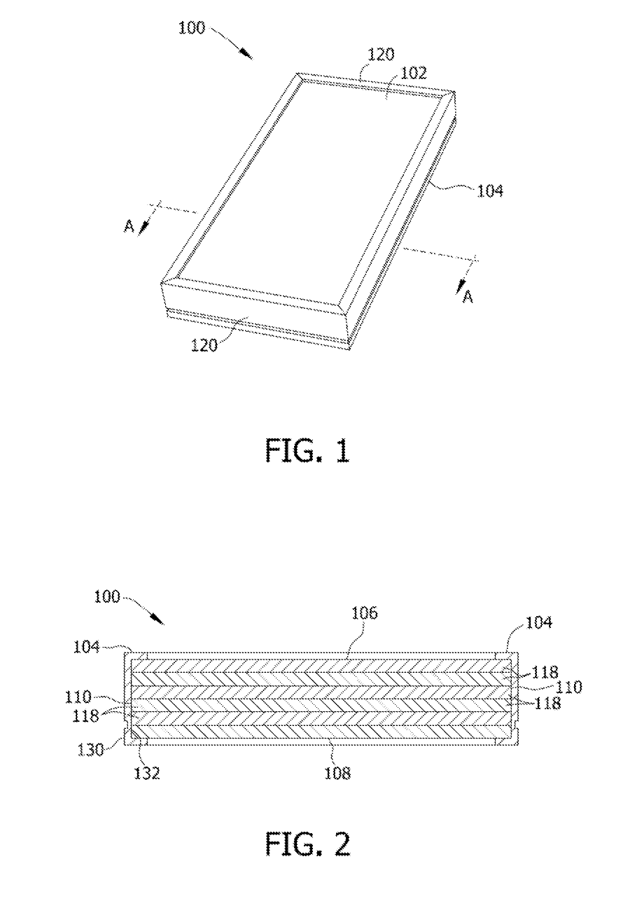

Referring initially to FIGS. 1 and 2, a PV module is indicated generally at 100. A perspective view of the PV module 100 is shown in FIG. 1. FIG. 2 is a cross sectional view of the PV module 100 taken at line A-A shown in FIG. 1. The PV module 100 includes a solar laminate 102 (also referred to as a PV laminate) and a frame 104 circumscribing the solar laminate 102.

The solar laminate 102 includes a top surface 106 and a bottom surface 108 (shown in FIG. 2). Edges 110 extend between the top surface 106 and the bottom surface 108. In this embodiment, the solar laminate 102 is rectangular shaped. In other embodiments, the solar laminate 102 may have any suitable shape.

As shown in FIG. 2, the solar laminate 102 has a laminate structure that includes several layers 118. Layers 118 may include for example glass layers, non-reflective layers, electrical connection layers, n-type silicon layers, p-type silicon layers, and/or backing layers. In other embodiments, solar laminate 102 may have more or fewer layers 118, including only one layer, or may have different layers 118, and/or may have different types of layers 118. The solar laminate 102 includes a plurality of solar cells (not shown), each of which converts solar energy to electrical energy. The outputs of the solar cells are connected in series and/or parallel to produce the desired output voltage and current for the solar laminate 102.

As shown in FIG. 1, the frame 104 circumscribes the solar laminate 102. The frame 104 is coupled to the solar laminate 102, as best seen in FIG. 2. The frame 104 assists in protecting the edges 110 of the solar laminate 102. In this embodiment, the frame 104 is constructed of four frame members 120. In other embodiments the frame 104 may include more or fewer frame members 120.

This frame 104 includes an outer surface 130 spaced apart from solar laminate 102 and an inner surface 132 adjacent solar laminate 102. The outer surface 130 is spaced apart from and substantially parallel to the inner surface 132. In this embodiment, the frame 104 is made of aluminum. More particularly, in some embodiments the frame 104 is made of 6000 series anodized aluminum. In other embodiments, the frame 104 may be made of any other suitable material providing sufficient rigidity including, for example, rolled or stamped stainless steel, plastic, or carbon fiber.

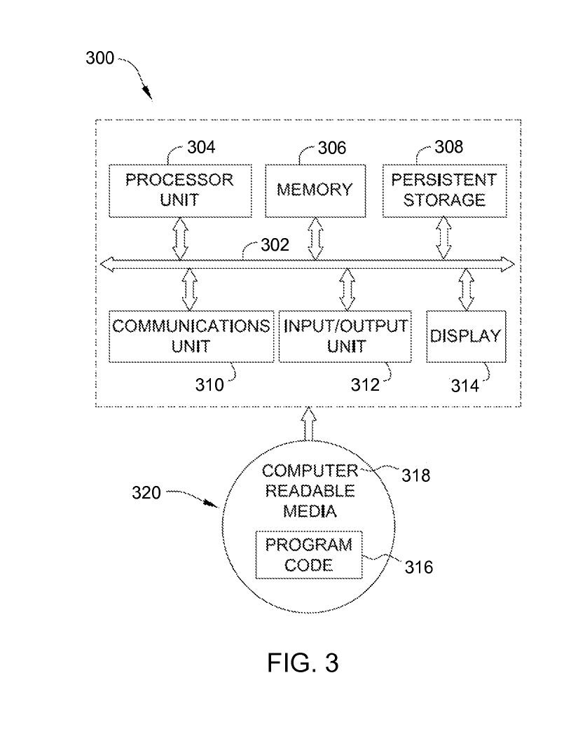

Some exemplary methods and systems are performed using and/or include computing devices. FIG. 3 is a block diagram of an exemplary computing device 300 that may be used. In the exemplary implementation, computing device 300 includes communications fabric 302 that provides communications between a processor unit 304, a memory 306, persistent storage 308, a communications unit 310, an input/output (I/O) unit 312, and a presentation interface, such as a display 314. In addition to, or in alternative to, the presentation interface may include an audio device (not shown) and/or any device capable of conveying information to a user.

Processor unit 304 executes instructions for software that may be loaded into a storage device (e.g., memory 306). Processor unit 304 may be a set of one or more processors or may include multiple processor cores, depending on the particular implementation. Further, processor unit 304 may be implemented using one or more heterogeneous processor systems in which a main processor is present with secondary processors on a single chip. In another implementation, processor unit 304 may be a homogeneous processor system containing multiple processors of the same type.

Memory 306 and persistent storage 308 are examples of storage devices. As used herein, a storage device is any tangible piece of hardware that is capable of storing information either on a temporary basis and/or a permanent basis. Memory 306 may be, for example, without limitation, random access memory (RAM) such as dynamic RAM (DRAM) or static RAM (SRAM), read-only memory (ROM), erasable programmable read-only memory (EPROM), electrically erasable programmable read-only memory (EEPROM), non-volatile RAM (NVRAM), and/or any other suitable volatile or non-volatile storage device. Persistent storage 308 may take various forms depending on the particular implementation, and persistent storage 308 may contain one or more components or devices. For example, persistent storage 308 may be one or more hard drives, flash memory, rewritable optical disks, rewritable magnetic tapes, and/or some combination of the above. The media used by persistent storage 308 also may be removable. For example, without limitation, a removable hard drive may be used for persistent storage 308.

A storage device, such as memory 306 and/or persistent storage 308, may be configured to store data for use with the processes described herein. For example, a storage device may store (e.g., have embodied thereon) computer-executable instructions, executable software components, PV system component data, PV system layouts, installation instructions, work orders, and/or any other information suitable for use with the methods described herein. When executed by a processor (e.g., processor unit 304), such computer-executable instructions and/or components cause the processor to perform one or more of the operations described herein.

Communications unit 310, in these examples, provides for communications with other computing devices or systems. In the exemplary implementation, communications unit 310 is a network interface card. Communications unit 310 may provide communications through the use of either or both physical and wireless communication links. Communication unit 310 provides communication to one or more element of the PV system.

Input/output unit 312 enables input and output of data with other devices that may be connected to computing device 300. For example, without limitation, input/output unit 312 may provide a connection for user input through a user input device, such as a keyboard and/or a mouse. Further, input/output unit 312 may send output to a printer. Display 314 provides a mechanism to display information, such as any information described herein, to a user. For example, a presentation interface such as display 314 may display a graphical user interface, such as those described herein. The communication device 310 may include one or more analog I/O.

Instructions for the operating system and applications or programs are located on persistent storage 308. These instructions may be loaded into memory 306 for execution by processor unit 304. The processes of the different implementations may be performed by processor unit 304 using computer implemented instructions and/or computer-executable instructions, which may be located in a memory, such as memory 306. These instructions are referred to herein as program code (e.g., object code and/or source code) that may be read and executed by a processor in processor unit 304. The program code in the different implementations may be embodied in a non-transitory form on different physical or tangible computer-readable media, such as memory 306 or persistent storage 308.

Program code 316 is located in a functional form on non-transitory computer-readable media 318 that is selectively removable and may be loaded onto or transferred to computing device 300 for execution by processor unit 304. Program code 316 and computer-readable media 318 form computer program product 120 in these examples. In one example, computer-readable media 318 may be in a tangible form, such as, for example, an optical or magnetic disc that is inserted or placed into a drive or other device that is part of persistent storage 308 for transfer onto a storage device, such as a hard drive that is part of persistent storage 308. In a tangible form, computer-readable media 318 also may take the form of a persistent storage, such as a hard drive, a thumb drive, or a flash memory that is connected to computing device 300. The tangible form of computer-readable media 318 is also referred to as computer recordable storage media. In some instances, computer-readable media 318 may not be removable.

Alternatively, program code 316 may be transferred to computing device 300 from computer-readable media 318 through a communications link to communications unit 310 and/or through a connection to input/output unit 312. The communications link and/or the connection may be physical or wireless in the illustrative examples. The computer-readable media also may take the form of non-tangible media, such as communications links or wireless transmissions containing the program code.

In some illustrative implementations, program code 316 may be downloaded over a network to persistent storage 308 from another computing device or computer system for use within computing device 300. For instance, program code stored in a computer-readable storage medium in a server computing device may be downloaded over a network from the server to computing device 300. The computing device providing program code 316 may be a server computer, a workstation, a client computer, or some other device capable of storing and transmitting program code 316.

Program code 316 may be organized into computer-executable components that are functionally related. Each component may include computer-executable instructions that, when executed by processor unit 304, cause processor unit 304 to perform one or more of the operations described herein.

The different components illustrated herein for computing device 300 are not meant to provide architectural limitations to the manner in which different implementations may be implemented. The different illustrative implementations may be implemented in a computer system including components in addition to or in place of those illustrated for computing device 300. For example, in some embodiments, computing device includes a global positioning system (GPS) receiver. Moreover, components shown in FIG. 3 can be varied from the illustrative examples shown. As one example, a storage device in computing device 300 is any hardware apparatus that may store data. Memory 306, persistent storage 308 and computer-readable media 318 are examples of storage devices in a tangible form.

In another example, a bus system may be used to implement communications fabric 302 and may include one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, without limitation, memory 306 or a cache such as that found in an interface and memory controller hub that may be present in communications fabric 302.

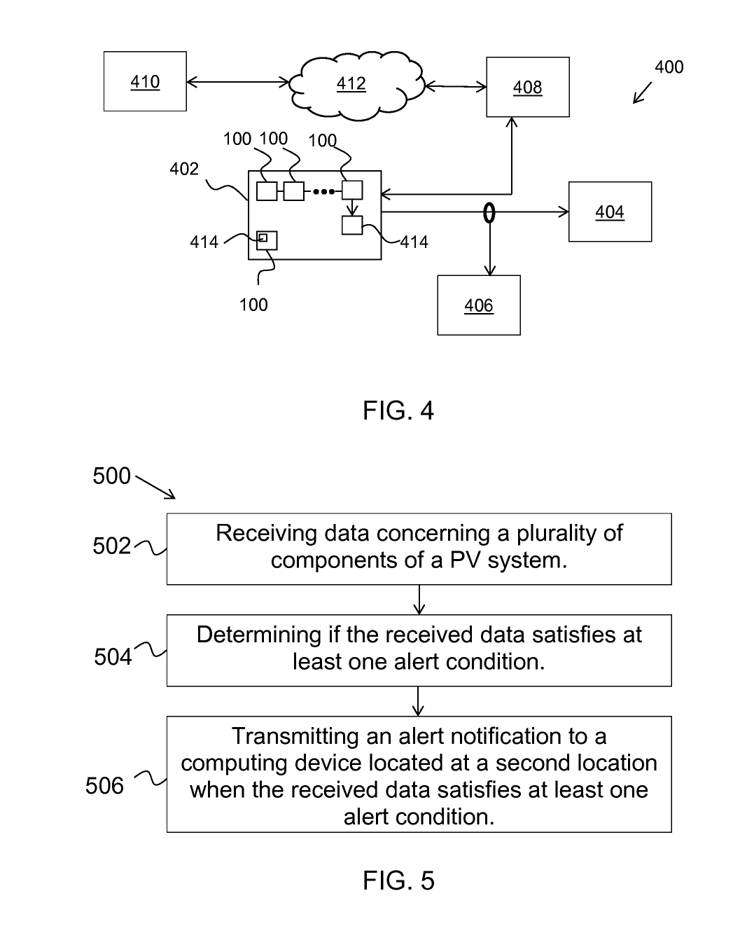

FIG. 4 is a block diagram of an exemplary PV system 400. The PV system 400 includes an array 402 of PV modules 100 and one or more inverters. The array 402 outputs AC power to one or more loads 404. A meter 406 measures the power delivered to the loads 404. A gateway device 408, also referred to as a data acquisition device, a data logger, or a data acquisition system (DAS), monitors the array 402 and transmits data collected from the array 402 to a backend system 410 via a network 412. Backend system 410 includes one or more computing devices 300. Backend system 410 is usually located at a second location physically separated from the first location at which PV system 400 is located. Alternatively, the second system may be located at the same site as the PV system 400. Moreover, the gateway device 408 may provide information to and communicate with more than one backend systems 410. The distance between the first location and the second location will vary among installed PV systems 400. In some embodiments, the first location and the second location are greater than five miles apart. In other embodiments, the first and second locations are more than ten miles apart, 25 miles apart, 50 miles apart, 100 miles apart, 200 miles apart, or even located on different continents.

The array 402 may be any suitable array of PV modules 100 and one or more inverters 414. For example, the array 402 may include a plurality of PV modules arranged in strings of PV modules. Each string of modules is connected to a single inverter to convert the DC output of the string of PV modules to an AC output. Alternatively, or additionally, each PV module may be coupled to its own inverter 414 (sometimes referred to as a microinverter) positioned near or on the PV module to which it is electrically coupled. In still other examples, a plurality of strings of PV modules may be connected, directly or through one or more string combiners, to a single inverter 414, sometimes referred to as a central or string inverter.

In embodiments that do not include microinverters, the array 402 may include a direct current power manager (DCPM) coupled to each PV module. The DCPM performs, for example, maximum power point tracking (MPPT) for the PV module. It may also selectively control (i.e., limit and/or increase) the maximum power output of the PV module and/or control the conduction of bypass diodes based on temperature and bypass current. The DCPM may also translates the output I-V curve of the PV module to a new I-V curve at which the output voltage does not vary with ambient temperature.

In some embodiments, the array 402 includes one or more tracking devices configured to selectively position the PV modules relative to the sun to attempt to maximize the solar energy incident on the PV modules over time. Any other suitable arrangement of PV modules and inverter(s) may be used, including combinations of the arrangements described above.

The gateway device 408 collects data concerning array 402, such as via one or more sensors (not shown). The gateway device 408 is and/or includes a computing device, such as computing device 300. The collected data may include any appropriate operational, situational, environmental, or other data related to the operation and/or condition of the array 402. For example, the gateway may monitor the ambient air temperature around the array 402, the amount of sunlight incident on the array 402 (or one or more PV module), the output voltage and current of the array 402, the output voltage and current of each PV module, the output voltage and current of each inverter and/or microinverter 414, the surface temperature of the PV modules 100, etc. Moreover, in some embodiments, the gateway device 408 is in communication with one or more components of the array 402. For example, the gateway device 408 may be in communication with one or more inverters 414 in the array 402. Each inverter 414 may provide the gateway device 408 with, for example, its input voltage, its input current, its output voltage, its output current, etc. In some embodiments, the array 402 (and more particularly the inverters 414) may be controlled via the gateway device 408.

In one example, the network 412 is the Internet. In other implementations, network 412 is any other suitable communication network, including, for example, a wide area network (WAN), a local area network (LAN), a cellular network, etc. Network 412 may include more than one network. For example, gateway device 408 may connect to the Internet through one or more other networks and/or interfaces, such as a local area network (LAN), a wide area network (WAN), a home area network (HAN), dial-in-connections, cable modems, and high-speed ISDN lines.

FIG. 5 is flow diagram of an exemplary method 500 for monitoring a PV system located at a first location. The method 500 will be described with reference to PV system 400 and the components of PV system 400, but the method 500 may be used in connection with any suitable PV system 400.

At 502, gateway device 408 at the first location receives data concerning a plurality of components of the PV system 400. The received data includes any suitable data concerning the PV system 400 and/or the components of the PV system. The received data may include, for example, voltage and/or current readings (input and/or output) from the inverters 414, temperature readings from temperature sensors, tracker position(s), irradiant readings from sunlight sensors, measurements from meters 406, status data (e.g., on/off) for components, measurements from other atmospheric sensors, and any other suitable data. The gateway device 408 may receive the data actively and/or passively. The gateway device 408 may actively request data from the components of the system and receive the data from the components in response to its request. Alternatively, or additionally, one or more component may push/send data to the gateway device 408 without receiving a request for the data (e.g., periodically or when a certain threshold value is met).

The gateway device 408 determines at 504 if the received data satisfies at least one alert condition. Gateway device 408 stores a plurality of alert conditions and compares the received data to the plurality of alert conditions to determine which, if any, of the alert conditions are satisfied. The alert condition may be any condition of which a technician or operator of system 400 may wish to be notified. For example, the alert conditions may include binary alerts, such as a particular component of the system 400 being turned off, or a voltage/temperature/current being above or below a threshold value. Alternatively, the alert conditions may be computed alerts and/or complex alerts. Computed alerts cover relationships between two or more variables and/or involve application of logical/mathematical expression (e.g., less than, if/then/else, addition, subtraction, multiplication, and division). For example, two or more variables may be combined or compared in an alert condition, such as an alert condition is satisfied if variable a<100 and variables b+c>200. Complex alert conditions are not limited to instantaneous data values or the received data. Complex alert conditions may rely on changes in data over time, regression analysis, or other data and/or analytic techniques. Some alert conditions may rely on data other than the received data concerning the components of the PV system. External variable may be received, e.g., from the backend system 410. For example, weather forecasts, data/estimates produced elsewhere, general system data 400 (such as physical layout, construction, part numbers and characteristics, and the like) may be stored by the gateway device 408 and one or more alert condition may utilize such other data.

In one example complex alert, a pyranometer reading is combined with an output of the PV system to determine whether an alert condition exists. For example, if a pyranometer senses/reports a value that indicates adequate sunlight is available for the PV system to produce a certain amount of energy, and at the same time the meter reports an energy output value that is significantly below the expected energy, something is wrong with the PV system. An alert condition is met because the system is not producing as much energy as expected for the present conditions.

Similarly, energy production significantly higher than expected based on the irradiation reported by the pyranometer may indicate a faulty or miss-calibrated pyranometer. Thus, another example complex alert condition may be satisfied when energy production as reported by the meter exceeds a threshold production determined based on the pyranometer reading.

At 506, when the received data satisfies at least one alert condition, the gateway device 408 transmits an alert notification to a computing device, such as a backend system 410 located at a second location. More specifically, gateway device 408 transmits to backend system 410 an alert notification corresponding to each alert condition that the received data satisfies. Each alert notification includes the alert condition that was satisfied. In some embodiments, the alert conditions include the data that satisfied the alert condition, or other suitable explanatory information. Alternatively, the gateway device 408 sends a single alert notification that includes all of the alert conditions satisfied within a certain time period (e.g., one day, one hour, 15 minutes, etc.).

Alert conditions and/or alert notifications have a hierarchical relationship in some example embodiments, in which the alert conditions are arranged by an order of importance/criticality. Thus, for example, an alert condition that is indicative of a critical, or potentially critical failure, may be prioritized over an alert condition that indicates a component operating slightly below optimal operation. The hierarchy may also be organized according to any other suitable criterion/criteria for ranking the importance of the alert conditions. For example, the alert conditions may be ranked by criticality to overall system performance, how quickly the alert condition will result in a failure of a component or the system, how much the alert condition will cost an operator of the system until the alert condition is remedied, etc. Because of the ranking/ordering of the alert conditions, the gateway device 408 may prioritize the transmission of alert notifications. Thus, more important/expensive/higher priority alert notifications may be transmitted before lower priority messages. Moreover, some alert notifications may be prioritized to be sent immediately, while other alert notification may have a lower priority indicating that transmission of the alert notification may wait until a scheduled transmission time, until no higher priority transmissions are occurring, until bandwidth is available for transmission, or the like. For example, when a high priority alert condition is satisfied, an alert notification may be transmitted immediately, while lower priority alert notifications and the received data are transmitted at a predetermined time of night.

Alert conditions and/or alert notifications are aggregated/combined in some example embodiments. For example, when two or more alert conditions are satisfied by the received data, some or all of the satisfied alert conditions or the alert notifications may be aggregated into an aggregated alert notification. The aggregated alert may include all of the satisfied alert conditions, or a subset of the satisfied alert conditions. More than one aggregated alert may be generated for a set of received data and satisfied alert conditions. Different aggregated alert notifications may be defined according to subject matter, severity of problem, location, or any other suitable basis. By combining multiple alerts into a reduced number of alerts, review of the alert notifications may be simplified, prioritization of examination of the alert notifications may be available, bandwidth usage may be reduced, etc. In an example embodiment, a first number of satisfied alert conditions are aggregated into a second number of aggregated alert notifications. The first number is a whole number greater than one, and the second number is a whole number less than the first number. Moreover, the system may aggregate only some alert notifications, while maintaining some alert notifications separately. For example, low priority alert notifications may be aggregated, while high priority alert notifications are kept separate. The aggregated low priority alert notification and the separate higher priority notifications may be transmitted to a remote computing device together or separately (e.g. the aggregated alert notification may be assigned a lower priority and transmitted at a later time). In another example, more than one alert condition that relate to a same (or similar) problem are aggregated into a single alert notification.

In some embodiments, the data received by the gateway device 408 is also transmitted to the backend system 410. The transmission of the received data to the gateway device 408 typically occurs at some time after the transmission of the alert notification(s) to the backend system 410. For example, the alert notification(s) may be transmitted to the backend system upon detection of data that satisfies an alert condition, while the received data is not sent to the backend system until a predetermined time (e.g., at midnight), a predetermined amount of time after transmission of the alert notification(s), or immediately following transmission of the alert notifications. Alternatively, the transmission of the received data and the alert notification(s) may occur at substantially the same time.

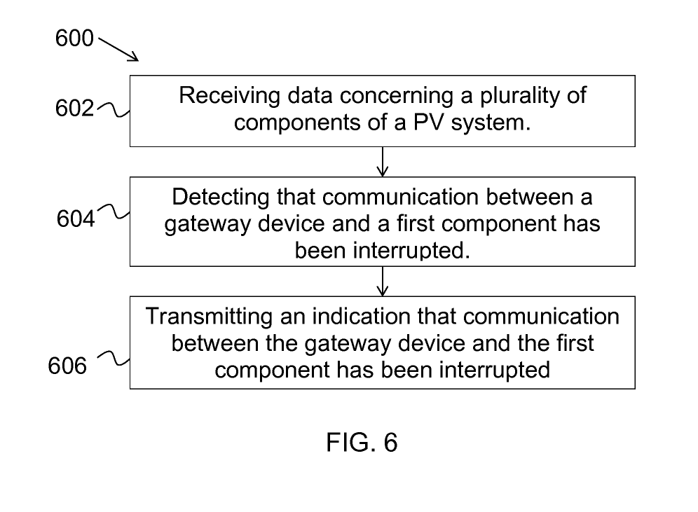

FIG. 6 is flow diagram of an exemplary method 600 for monitoring a PV system located at a first location. The method 600 will be described with reference to PV system 400 and the components of PV system 400, but the method 600 may be used in connection with any suitable PV system 400.

At 602, the gateway device 408 receives, at the first location, data concerning a plurality of components of the PV system 400. The received data includes any suitable data concerning the PV system 400 and/or the components of the PV system. The received data may include, for example, voltage and/or current readings (input and/or output) from the inverters 414, temperature readings from temperature sensors, tracker position(s), irradiation readings from pyranometers, measurements from meter 406, status data (e.g., on/off) for components, measurements from other atmospheric sensors, and any other suitable data. Generally, the received data will be transmitted to a remote computing device, such as a computing device of backend system 410. Additionally, or alternatively, the received data may be processed by the gateway device 408 as described above.

The gateway device 408 detects, at 604, that communication between the gateway device 408 and a first component (e.g., an inverter, a sensor, a DCPM, etc.) of the PV system has been interrupted. In some embodiments, the gateway device 408 also detects that an expected data element (e.g., a datum) associated with the first component has not been received. Thus for example, the gateway device may expect to receive an output datum from each inverter. If the gateway device 408 does not receive an output datum from a particular inverter, it may be due to a failure of communication between the inverter and the gateway device 408. In some embodiments, the detection that an expected data element was not received from a first component is also detection that communication between the gateway device 408 and the first component may have been interrupted. Alternatively, or additionally, the gateway device 408 may detect that communication between the gateway device 408 and the first component has been interrupted by checking the status of the communication driver. If the communication driver returns a failed communication, a timeout, or other communication related error, the gateway device 408 knows that communication with the component has failed or been interrupted. Alternatively, the gateway device 408 detects a communication interruption by attempting communication with the first component. If the attempted communication with the first component fails (e.g., the gateway device 408 does not receive a response from the first component), the gateway device 408 determines that communication with the first component has been interrupted.

At 606, the gateway device 408 transmits, to a computing device located at a second location (e.g., to a computing device of backend system 410), an indication that communication between the gateway device 408 and the first component of the plurality of PV components has been interrupted. In an example embodiment, the gateway device assigns a null value (which is different than a zero) to the data element associated with the first component for which the gateway device 408 did not receive a value. The gateway device 408 transmits the data element with the null value to the backend system 410. The data element with a null value indicates to the backend system that a communication interruption has occurred with respect to the first component because of the null value assigned to the first component's data element. In other embodiments, the value assigned to the data element is any other non-zero value that indicates to the backend system 410 that a communication failure has occurred. Alternatively, or additionally, gateway device 408 transmits the indication by transmitting an alert notification to the backend system 410. The alert notification includes any suitable information to inform the backend system 410 that a communication interruption has occurred between the gateway device 408 and the first component. In some embodiments, the gateway device 408 transmits the alert notification and later transmits the data element with the null value (with or without the other received data). The gateway device transmits a notification of the communication error to the backend system 410 along with a notification of an unknown value for the data element.

A technical effect of the method, device, and system described herein may include one or more of: (a) receiving, at a first location, data concerning a plurality of components of a PV system; (b) determining if the received data satisfies at least one alert condition; (c) transmitting an alert notification to a computing device located at a second location when the received data satisfies at least one alert condition; (d) detecting that communication between the gateway device and a first component has been interrupted; and (e) transmitting an indication that communication between the gateway device and the first component has been interrupted.

The methods and systems of the present disclosure provide monitoring of a PV system at a location using a combination of equipment at the first location and the backend system at a second, remote location. The local gateway device processes data about the PV system rather than simply sending the data to the remote backend system. The local gateway device can determine if alert conditions have been met and send alerts to the backend system. The alert conditions can be individually set and/or adjusted locally and/or remotely. The system may also mitigate certain alerts locally without any delay and without adding additional load to the backend. Because the backend system may monitor many PV systems, the time required for it to process all of the data it receives may be relatively long. The backend system may respond faster to the alert conditions because it does not need to process all of the data to determine that the alert conditions have been satisfied. Transferring some computation/analysis to the local gateway device reduces demands on the backend system and produces an efficient, cost effective, and scalable monitoring system. The gateway device may also prioritize and/or rank multiple alerts based on certain criteria and send only the highest priority alert to the backend, further reducing the required bandwidth and backend processing. Moreover, by distinguishing between a zero value for an element of data and a lack of data (caused by, for example, a failure of communication), the exemplary systems allow remotely located systems (such as the backend system) and technicians to more accurately monitor the PV systems and have a more accurate picture of the current status of the PV systems.

This written description uses examples to disclose various embodiments, which include the best mode, to enable any person skilled in the art to practice those embodiments, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

1. A method of monitoring a photovoltaic (PV) system located at a first location, the method comprising:
receiving, by a gateway device at the first location, data concerning a plurality of components of the PV system;
determining, by the gateway device, if the received data satisfies at least one alert condition; and
transmitting, by the gateway device, an alert notification to a computing device located at a second location when the received data satisfies at least one alert condition.

2. The method of claim 1, further comprising transmitting the received data to the computing device located at the second location.

3. The method of claim 1, wherein determining if the received data satisfies at least one alert condition comprises comparing the received data to a plurality of alert conditions to determine if the received data satisfies at least one of the plurality of alert conditions.

4. The method of claim 1, wherein transmitting an alert notification to a computing device located at a second location comprises transmitting the alert notification to a backend monitoring system.

5. The method of claim 4, wherein transmitting the alert notification to a backend monitoring system comprises transmitting the alert notification to the backend monitoring system via a network.

6. The method of claim 4, wherein a distance between the first location and the second location is at least ten miles.

7. The method of claim 1, wherein transmitting an alert notification to a computing device located at a second location comprises transmitting an alert notification including the at least one alert condition that was satisfied.

8. The method of claim 1, wherein the alert condition is one of a binary alert, a computed alert, and a complex alert.

9. A gateway device for acquiring data concerning a photovoltaic (PV) system including a plurality of PV components at a first location, the gateway device comprising a processor and a memory coupled to the processor, wherein the memory comprises computer-executable instructions that, when executed by the processor, cause the gateway device to:
receive data concerning the plurality of components of the PV system;
determine if the received data satisfies at least one alert condition; and
transmit an alert notification to a computing device located at a second location when the received data satisfies at least one alert condition.

10. The gateway device of claim 9, wherein the memory further comprises computer-executable instructions that, when executed by the processor, cause the gateway device to transmit the received data to the computing device located at the second location.

11. The gateway device of claim 9, wherein the memory further comprises computer-executable instructions that, when executed by the processor, cause the gateway device to determine if the received data satisfies at least one alert condition by comparing the received data to a plurality of alert conditions to determine if the received data satisfies at least one of the plurality of alert conditions.

12. The gateway device of claim 9, wherein the memory further comprises computer-executable instructions that, when executed by the processor, cause the gateway device to transmit the alert notification to a backend monitoring system.

13. The gateway device of claim 9, wherein the memory further comprises computer-executable instructions that, when executed by the processor, cause the gateway device to transmit the alert notification to the backend monitoring system via a network.

14. The gateway device of claim 9, wherein the memory further comprises computer-executable instructions that, when executed by the processor, cause the gateway device to transmit the alert notification including the at least one alert condition that was satisfied.

15. A computer-readable storage device having non-transitory, computer-executable instructions embodied thereon, wherein when executed by a gateway device at a first location comprising a processor and a memory coupled to the processor, the computer-executable instructions cause the gateway device to:
receive data concerning a plurality of components of a photovoltaic (PV) system located at the first location;
determine if the received data satisfies at least one alert condition; and
transmit an alert notification to a computing device located at a second location when the received data satisfies at least one alert condition.

16. The computer-readable storage device of claim 15, further comprising computer-executable instructions that cause the gateway device to transmit the received data to the computing device located at the second location.

17. The computer-readable storage device of claim 15, further comprising computer-executable instructions that cause the gateway device to determine if the received data satisfies at least one alert condition by comparing the received data to a plurality of alert conditions to determine if the received data satisfies at least one of the plurality of alert conditions.

18. The computer-readable storage device of claim 15, further comprising computer-executable instructions that cause the gateway device to transmit the alert notification to a backend monitoring system.

19. The computer-readable storage device of claim 15, further comprising computer-executable instructions that cause the gateway device to transmit the alert notification to the backend monitoring system via a network.

20. The computer-readable storage device of claim 15, further comprising computer-executable instructions that cause the gateway device to transmit the alert notification including the at least one alert condition that was satisfied.

21.-38. (canceled)

39. The method of claim 1, wherein the gateway device stores a plurality of alert conditions, wherein the plurality of alert conditions is hierarchically organized by priority.

40. The method of claim 39, wherein transmitting an alert notification when the received data satisfies at least one alert condition comprises transmitting alert notifications for alert conditions that have a higher priority before transmitting alert notifications for alert conditions that have a lower priority.

41. The method of claim 40, wherein transmitting alert notifications for alert conditions that have a higher priority before transmitting alert notifications for alert conditions that have a lower priority comprises transmitting alert notifications for alert conditions that have a priority above a threshold priority upon determining that said alert conditions have been satisfied.

42. The method of claim 41, wherein transmitting alert notifications for alert conditions that have a higher priority before transmitting alert notifications for alert conditions that have a lower priority further comprises transmitting alert notifications for alert conditions that have a priority below the threshold priority at a predetermined time after determining that said alert conditions have been satisfied.

43. The gateway device of claim 9, wherein the memory further comprises a plurality of alert conditions hierarchically organized by priority, and wherein the at least one alert condition comprises at least one alert condition of the plurality of alert conditions.

44. The gateway device of claim 43, wherein the memory further comprises computer-executable instructions that, when executed by the processor, cause the gateway device to transmit alert notifications for alert conditions that have a higher priority before transmitting alert notifications for alert conditions that have a lower priority.

45. The gateway device of claim 44, wherein the memory further comprises computer-executable instructions that, when executed by the processor, cause the gateway device to transmit alert notifications for alert conditions that have a priority above a threshold priority upon determining that said alert conditions have been satisfied.

46. The gateway device of claim 45, wherein the memory further comprises computer-executable instructions that, when executed by the processor, cause the gateway device to transmit alert notifications for alert conditions that have a priority below the threshold priority at a predetermined time after determining that said alert conditions have been satisfied.

47. The computer-readable storage device of claim 15, further comprising a plurality of alert conditions hierarchically organized by priority, and wherein the at least one alert condition comprises at least one alert condition of the plurality of alert conditions.

48. The computer-readable storage device of claim 47, further comprising computer-executable instructions that cause the gateway device to transmit alert notifications for alert conditions that have a higher priority before transmitting alert notifications for alert conditions that have a lower priority.

49. The computer-readable storage device of claim 48, further comprising computer-executable instructions that cause the gateway device to transmit alert notifications for alert conditions that have a priority above a threshold priority upon determining that said alert conditions have been satisfied.

50. The computer-readable storage device of claim 49, further comprising computer-executable instructions that cause the gateway device to transmit alert notifications for alert conditions that have a priority below the threshold priority at a predetermined time after determining that said alert conditions have been satisfied.

51. The method of claim 1, further comprising aggregating a first number of alert conditions satisfied by the received data into a second number of aggregated alert notifications, wherein the first number is a whole number greater than one and the second number is a whole number less than the first number.

52. The method of claim 51, wherein transmitting an alert notification when the received data satisfies at least one alert condition comprises transmitting at least one aggregated alert notification.
